(19) United States
(12) Patent Application Publication
(10) Pub. No.: US 2005/0040928 A1
(43) Pub. Date: Feb. 24, 2005

(54) Voltage-compensated resistive touch panel

(76) Inventors: Kao Wan Lee, Taipei City (TW); Wei Jen Tai, Sindian City (TW)

Correspondence Address: BIRCH STEWART KOLASCH & BIRCH, PO BOX 747, FALLS CHURCH, VA, 22040-0747, US

(21) Appl. No.: 10/642,327

(22) Filed: Aug. 18, 2003

(51) Int. Cl. H01C 10/10

(52) U.S. Cl. 338/47

(57) ABSTRACT

The present invention provides a voltage-compensated resistive touch panel. The panel includes: a rectangle substrate; a uniform resistive surface being uniformly coated on the rectangle substrate; a plurality of resistance elements being formed on the perimeter edges of the uniform resistive surface so as to create orthogonal electrical fields therein while a DC power is applied; a plurality of compensating elements being spaced along the perimeter edges of the uniform resistive surface, wherein the sizes of them and the intervals among each others are respectively proportional and inversely proportional to the distances being apart from the edges of the uniform resistive surface so as to compensate the bow equipotential lines generated by the orthogonal electrical fields; a touch film being uniformly coated a conductive material on the surface facing the uniform resistive surface; and a plurality of insulators uniformly spreading between the uniform resistive surface and the touch film.

### BACKGROUND OF THE INVENTION

1. Field of the Invention

This invention generally relates to the field of touch panels. More particularly, the invention relates to a voltage-compensated resistive touch panel.

2. Description of the Prior Art

As flat panel displays increasingly substitute for traditional CRT displays, touch panels are also broadly used in displaying systems, such as PDA, tablet PC, ATM, kiosk, etc., owing to their convenient inputting and their producing processes having been improving. Generally speaking, the resistance of the resistance elements along the perimeter edges of a traditional resistive touch panel is proportion to the distances being apart from the edges of the panel. This situation makes the resistance values measured at both edges smaller than those measured at middle edges, further resulting in the voltages beside the both edges being higher than those at the middle edges, and forms bow equipotential lines. Such bow equipotential lines cause the sensing errors between reactive and real touched positions as well as reduce the active region of the panel.

As shown in FIG. 1, an equipotential line paralleling to and affected by compensating elements is illustrated. Resistance elements Rₕ are serially connected from the both ends to the middle, and hence the resistance gradually increases from the both ends to the middle as well. When there are no compensating elements, eₐ and e_{b}, and a 5-voltage DC power is applied at the both ends, a bow equipotential line 110 is formed because of the gradually decreased voltage from the both ends to the middle. However, the compensating elements eₐ and e_{b} adjust the whole resistance value of the resistance elements Rₕ to achieve the voltage compensation. Basically, the compensating element eₐ is wider than the compensating element e_{b}, and hence the resistance of the X length of the compensating element eₐ extending to a uniform resistive surface is less than the resistance of the X length of the compensating element e_{b} extending to the uniform resistive surface. That is, the high resistance is compensated at the both ends having lower resistance but the low resistance is compensated at the middle having higher resistance. By doing so, the different resistance values caused by serially connecting different amount of the resistance elements Rₕ within each section can be thoroughly uniformed. The bow equipotential line 110 can be compensated like equipotential line 120. Yet, the equipotential line 120 requires a longer X length, and a little bit of bow still exists on the equipotential line 120 among each compensating element. Therefore, another longer X′ length extending to the uniform resistive surface is required to acquire an equipotential line 120′.

As shown in FIG. 2, an equipotential line having a vertical direction to and affected by the compensating elements is illustrated. A 5-voltage DC power gradually decreases as the resistance value of the resistance elements Rₕ accumulatively increasing, so that a plurality of different voltage gradient equipotential lines 210 are formed. However, the equipotential lines 210 are also affected by compensating element e_{c} and e_{d}. Therefore, the ends of the equipotential lines 210 generate the bow statuses close the compensating element e_{c} and e_{d}. These statuses also result in the sensing errors between reactive and real touched positions as well as reduce the active region of the panel.

In view of the drawbacks mentioned with the prior art of resistive touch panels, there is a continued need to develop a new and improved method and device that overcomes the disadvantages associated with the prior art of the resistive touch panels. The advantages of this invention are that it solves the problems mentioned above.

### SUMMARY OF THE INVENTION

In accordance with the present invention, a resistive touch panel with voltage compensation substantially obviates one or more of the problems resulted from the limitations and disadvantages of the prior art mentioned in the background.

Accordingly, one object of the present invention is to provide a voltage-compensated resistive touch panel for improving the linearity of the equipotential lines thereof by using the compensating elements.

Another object is to provide a voltage-compensated resistive touch panel for extending the active region thereof through improving the structure and layout of the compensating elements.

Still another object is to provide a voltage-compensated resistive touch panel for increasing the sensitivity in a slight distance through utilizing the high resistive material as the resistance elements.

According to the aforementioned objects, the present invention provides a voltage-compensated resistive touch panel. The panel includes a rectangle substrate, a uniform resistive surface, a plurality of resistance elements, a plurality of compensating elements, a touch film, and a plurality of insulators. The uniform resistive surface is uniformly coated on the rectangle substrate. The plurality of resistance elements are formed on the perimeter edges of the uniform resistive surface so as to create orthogonal electrical fields therein while a DC power is applied. The plurality of compensating elements are spaced along the perimeter edges of the uniform resistive surface, wherein the sizes of them and the intervals between each others are respectively proportional and inversely proportional to the distances being apart from the edges of the uniform resistive surface. That is, the sizes of the compensating elements beside the both ends of the uniform resistive surface are smaller than those at the middle of the uniform resistive surface, but the intervals among the compensating elements beside the both ends are wider than those at the middle. By doing so, the bow equipotential lines generated by the orthogonal electrical fields can be compensated. The touch film is uniformly coated a conductive material on the surface facing the uniform resistive surface. The plurality of insulators uniformly spread between the uniform resistive surface and the touch film.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1 and 2 illustrate the effects of the equipotential lines affected by the compensating elements in the prior art;

FIG. 3A illustrates the compensation principle of the compensating elements in the prior art;

FIG. 3B illustrates the compensating elements of a preferable embodiment in accordance with the present invention;

FIGS. 4A and 4B respectively illustrate the improving statuses in FIG. 1 and FIG. 2 through the preferable embodiment in accordance with the present invention;

FIG. 5A illustrates the preferable embodiment in accordance with the present invention; and

FIG. 5B illustrates a cross-sectional view of FIG. 5A.

### DESCRIPTION OF THE PREFERRED EMBODIMENT

Some embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

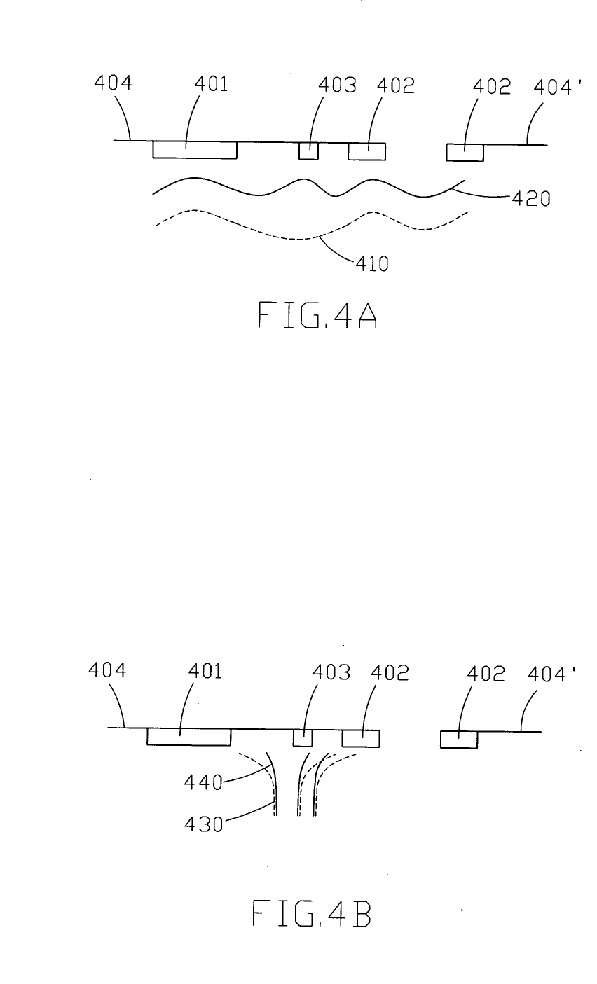

Referring to FIG. 3A, compensating elements R₀˜R₂ achieve the object of voltage compensation by adjusting the whole resistance value of the resistance elements Rₕ. Basically, the resistance of R₀ is higher than the resistance of R₁ and further higher than the resistance of R₂. That is, the high resistance is compensated at the both ends having lower resistance but the low resistance is compensated at the middle having higher resistance. By doing so, the different resistance values caused by serially connecting different amount of the resistance elements Rₕ within each section can be thoroughly uniformed. As shown in FIG. 3B, the structure of the compensating elements in one of preferable embodiment in accordance with the present invention is illustrated. The compensating elements R₀˜R₂, basically, are formed on the indium-tin oxide (ITO) layer coated on a glass substrate via an etching process. As having the same height h and the width of R₂ being wider than the width of R₁ and further wider than the width of R₀, the resistance of R₂ is less than the resistance of R₁ and further less than the resistance R₀ since the resistance value is inversely proportional to the width of the conductive wire. By doing so, the object of uniforming the resistance value of the resistance element within each section can be achieved. Wherein, the geometric pattern of the compensating elements R₀˜R₂ is a rectangle in the present embodiment (It is noted that the geometric pattern of the compensating elements should not be only limited to rectangle). Moreover, the relationships between the sizes of the compensating elements R₀˜R₂ and the interval distances among thereof are shown in Formula 1 as following:
LCn=((n*((DA/LA)*RG+RL)*C)/DB)−LC0 (Formula 1)
where n represents the compensated section number, LCn represents the compensated width of the n^{th} section (unit: inch), DA represents the line distance of each section of silver paste (unit: inch), LA represent the contact length between each section of silver paste and ITO (unit: inch), RG represent the glass surface resistance (unit: ohm), RL represents the line resistance of each section of silver paste (unit: ohm), C represents an adjust constant (about 45.3, depending on the resistance of substrate), DB represents the distance of silver paste pattern (unit: inch), and LC0 represents the width (a known value) of the 0^{th} section (unit: inch).

For example, when the compensated width in the 0^{th} section is 30 (0.03 inches), the compensated width in the fifth section is 48 (0.48 inches). The calculating process is shown in Formula 2 as below:
LC5=((5*((0.02/0.73)*500+2.5)*45.3)/7.19)−30=480 (Formula 2)
where the data listed above is only the preferable data in the present embodiment, however the data should be modified or adjusted to meet the practical material in order to get the perfect compensation effects.

In the present embodiment, the compensating elements R₀˜R₂ are formed by an etching process, so larger resistance differences exist among the R₀˜R₂ each other. This takes an advantage for a short h length compared to the X length in the prior art. Also, the lead lines for connecting the compensating elements in the prior art are omitted in the present embodiment. Hence, the active region of the touch panel is also extended. Besides, the low temperature silver paste could be utilized as the material of the resistance elements in the present embodiment. Since the low temperature silver paste possesses the characteristic of high resistance (higher than the high temperature silver paste about 10 times), the resistance elements can generate enough voltage differences for sensing even in a slight distance. Hence, the sensitivity in a slight distance for the touch panel can be increased.

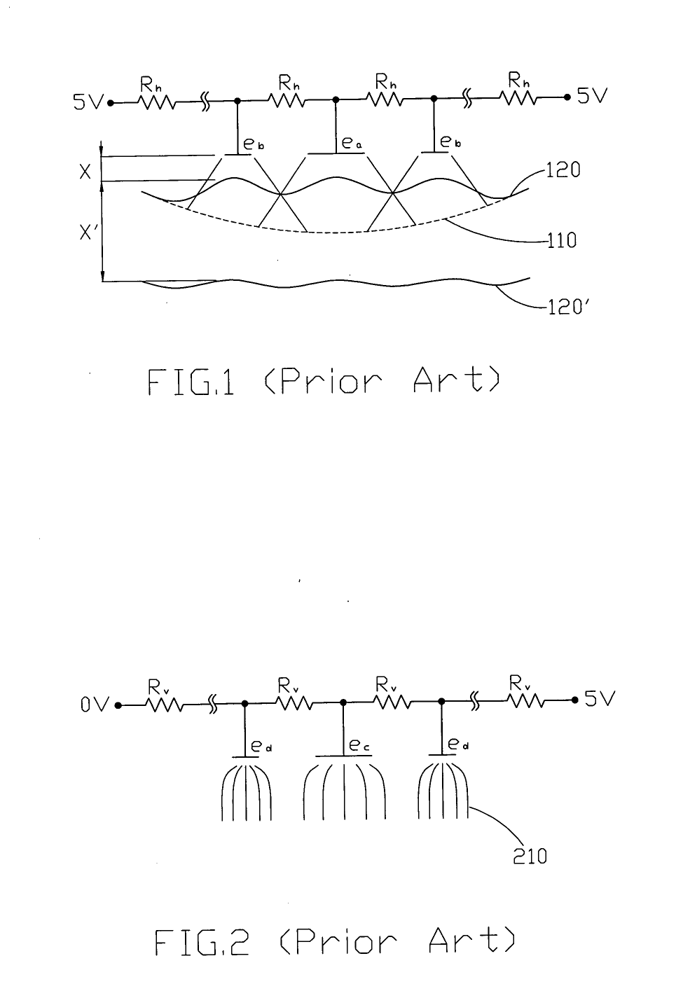

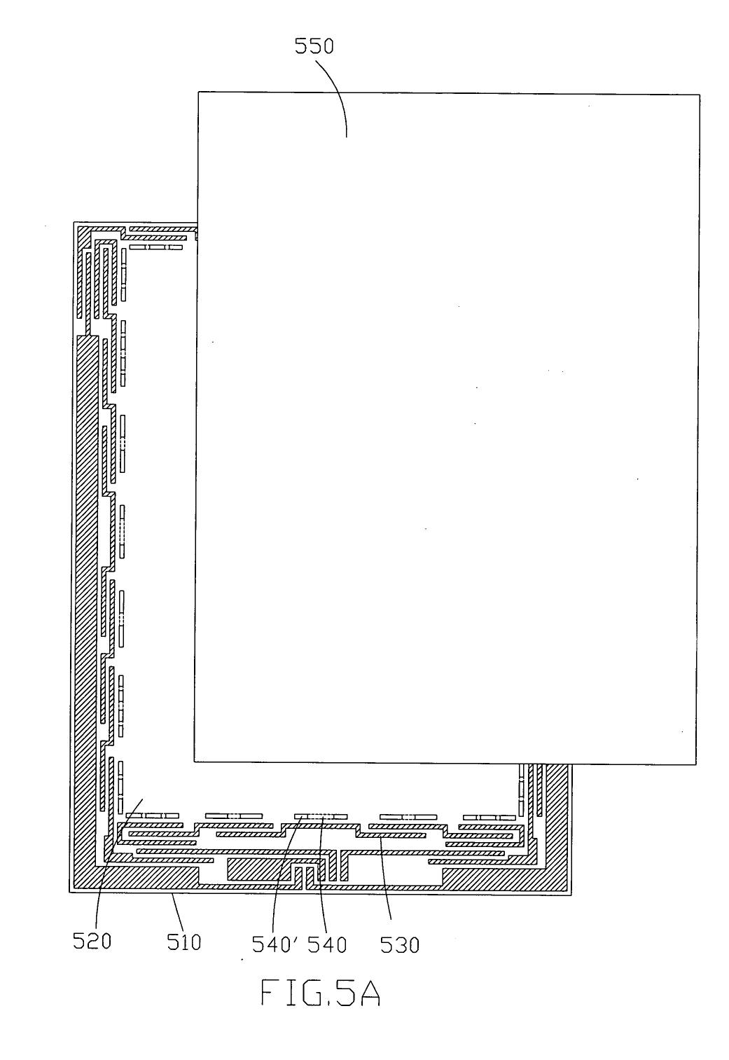

As shown in FIG. 4A, the compensating elements in the present embodiment compensate the horizontal equipotential lines. An equipotential line 410 is formed through compensating elements (not shown) of the prior art to compensate the equipotential line generated by resistance elements 404, 404′. An equipotential line 420 is formed through compensating elements 401, 402, 402′ (formed on the uniform resistive surface by an etching process) of the present embodiment to compensate the equipotential line. One of the main differences between the equipotential line 410 and the equipotential line 420 is that the latter is closer the panel edge than the former being. This situation results from the lead lines are omitted, and hence increases the active region of the panel. In addition, the linearity of the equipotential line 420 is better than the linearity of the equipotential line 410, since a detail-compensating element 403 is added between the compensating elements 401, 402 to compensate more detail voltage, so that a shorter length Y can compensate and generate the approximate straight line of equipotential line 420′. Thus, the present embodiment improves the status described in the FIG. 1.

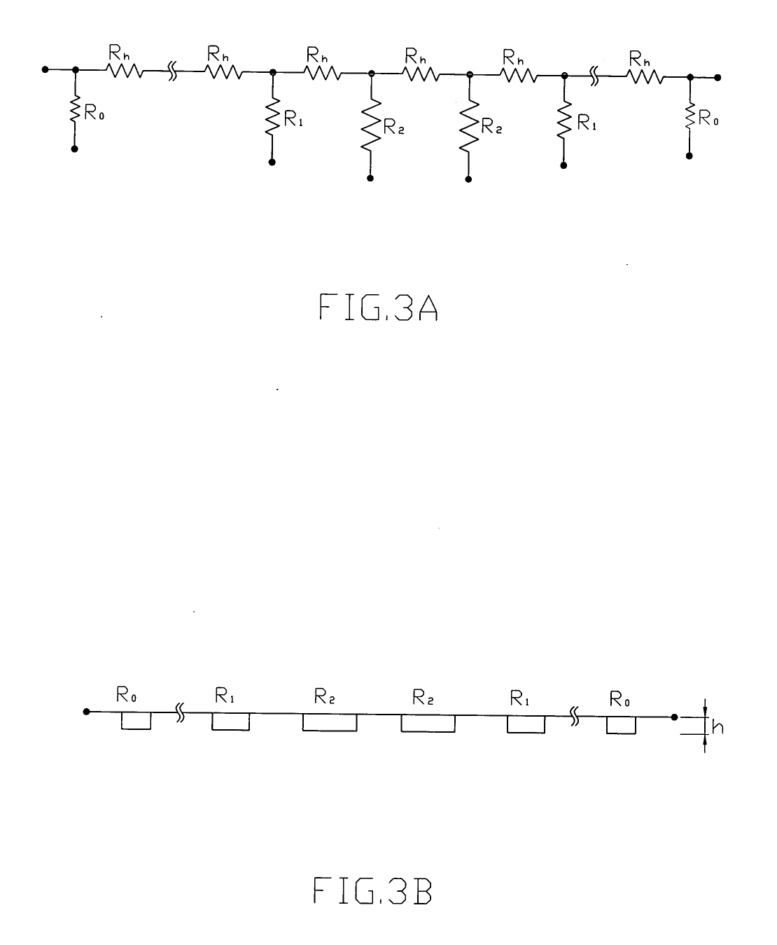

Similarly, as shown in FIG. 4B, the compensating elements in the present embodiment affect the vertical equipotential lines. Lines 404, 404′ simply represent the resistance elements. An equipotential line 430 is formed through compensating elements (not shown) of the prior art affecting the equipotential line. An equipotential line 440 is formed through compensating elements 401, 402, 402′, 403 (formed on the uniform resistive surface by an etching process) of the present embodiment affecting the equipotential line. Through applying the feature of the low temperature silver paste possessing high resistance to generate voltage differences, and space locating the compensating elements 401, 402, 402′, 403 equally between the resistance elements 404 and 404′ to divide the voltage, the equipotential line 430 is hence adjusted to the equipotential line 440. In other words, the present embodiment improves the status described in the FIG. 2.

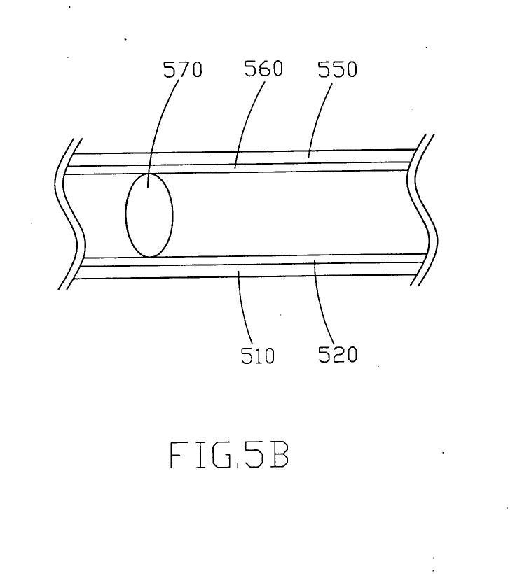

FIG. 5A illustrates a structure of a resistive touch panel with voltage compensation in accordance with the present invention. FIG. 5B illustrates a cross-sectional view of the structure shown in FIG. 5A. Referring to both of them, a voltage-compensated resistive touch panel in accordance with the present invention at least includes a rectangle substrate 510, a uniform resistive surface 520, a plurality of resistance elements 530, a plurality of compensating elements 540, and a touch film 550. The rectangle substrate 510, basically, is a rectangle glass, and also could be a soft and transparent circuit board. The uniform resistive surface 520 is uniformly coated on the rectangle substrate 510, wherein the material of the uniform resistive surface 520 in the present embodiment is the indium-tin oxide (ITO). The plurality of resistance elements 530 are formed on the perimeter edges of the uniform resistive surface 520 so as to create orthogonal electrical fields therein while a DC power is applied. Wherein, the material of the resistance elements 530 is the low temperature silver paste. Since the low temperature silver paste possesses the characteristic of high resistance (higher than the high temperature silver paste about 10 times), the touch panel can generate enough voltage differences for sensing even in a slight distance.

The plurality of compensating elements 540 are spaced along the perimeter edges of the uniform resistive surface 520, wherein the sizes of them and the intervals between each others are respectively proportional and inversely proportional to the distances being apart from the edges of the uniform resistive surface 520. That is, the sizes of the compensating elements 540 beside the both ends of the uniform resistive surface 520 are smaller than those at the middle of the uniform resistive surface 520, but the intervals among the compensating elements 540 beside the both ends are wider than those at the middle. By doing so, the bow equipotential lines generated by the orthogonal electrical fields mentioned above can be compensated. Further, the relationships between the sizes of the compensating elements 540 and the interval distances among thereof are now described in details as following: LCn=((n*((DA/LA)*RG+RL)*C)/DB)−LC0, where n represents the compensated section number, LCn represents the compensated width of the n^{th} section (unit: inch), DA represents the line distance of each section of silver paste (unit: inch), LA represent the contact length between each section of silver paste and ITO (unit: inch), RG represent the glass surface resistance (unit: ohm), RL represents the line resistance of each section of silver paste (unit: ohm), C represents an adjust constant (about 45.3), DB represents the distance of silver paste pattern (unit: inch), and LC0 represents the width (a known value) of the 0^{th} section (unit: inch). In addition, principally, the material of the plurality of compensating elements 540 and the material of the uniform resistive surface 520 are the same. The plurality of compensating elements 540 are formed during an etching process of the uniform resistive surface 520 removing the blocks 540′.

The touch film 550 is uniformly coated a conductive material on the surface facing the uniform resistive surface 520. Wherein, the touch film 550 could be a transparent plastic film and the conductive material in the present embodiment is the indium-tin oxide (ITO). The plurality of insulators 570 uniformly spread between the uniform resistive surface 520 and the touch film 550 to form a dot spacer to prevent from the unintended touch between both of them.

Although specific embodiments have been illustrated and described, it will be obvious to those skilled in the art that various modifications may be made without departing from what is intended to be limited solely by the appended claims.

1. A voltage-compensated resistive touch panel, comprising:
a rectangle substrate;
a uniform resistive surface being uniformly coated on said rectangle substrate;
a plurality of resistance elements being formed on the perimeter edges of said uniform resistive surface, so as to create orthogonal electrical fields therein while a DC power is applied;
a plurality of compensating elements being spaced along the perimeter edges of said uniform resistive surface by an etching process, wherein the sizes of said plurality of compensating elements and the intervals among each said plurality of compensating elements are respectively proportional and inversely proportional to the distances being apart from the edges of said uniform resistive surface, so as to compensate bow equipotential lines generated by said orthogonal electrical fields;
a touch film being uniformly coated a conductive material on the surface facing said uniform resistive surface; and
a plurality of insulators uniformly spreading between said uniform resistive surface and said touch film.

2. The panel according to claim 1, wherein said rectangle substrate comprises a glass substrate.

3. The panel according to claim 1, wherein the material of said uniform resistive surface comprises indium-tin oxide (ITO)

4. The panel according to claim 1, wherein the material of said plurality of resistance elements comprises low temperature silver paste.

5. The panel according to claim 1, wherein the relationships of said sizes and said intervals among said plurality of compensating elements comprise the steps of:
LCn=((n*((DA/LA)*RG+RL)*C)/DB)−LC0
where n represents the compensated section number, LCn represents the compensated width of the nth section (unit: inch), DA represents the line distance of each section of silver paste (unit: inch), LA represent the contact length between each section of silver paste and ITO (unit: inch), RG represent the glass surface resistance (unit: ohm), RL represents the line resistance of each section of silver paste (unit: ohm), C represents an adjust constant (about 45.3), DB represents the distance of silver paste pattern (unit: inch), and LC0 represents the width (a known value) of the 0^{th} section (unit: inch).

6. The panel according to claim 1, wherein said touch film comprises a transparent plastic film.

7. The panel according to claim 1, wherein said conductive material comprises said indium-tin oxide (ITO).

8. The panel according to claim 1, wherein said plurality of insulators forms a dot spacer to prevent from an unintended touch between said uniform resistive surface and said touch film.

9. A uniform resistive surface for a voltage-compensated resistive touch panel, said uniform resistive surface comprising:
a uniform resistive surface;
a plurality of resistance elements being formed on the perimeter edges of said uniform resistive surface, so as to create orthogonal electrical fields therein while a DC power is applied; and
a plurality of compensating elements being spaced along the perimeter edges of said uniform resistive surface by an etching process, wherein the sizes of said plurality of compensating elements and the intervals among each said plurality of compensating elements are respectively proportional and inversely proportional to the distances being apart from the edges of said uniform resistive surface, so as to compensate bow equipotential lines generated by said orthogonal electrical fields.

10. The surface according to claim 9, wherein the material of said uniform resistive surface comprises indium-tin oxide (ITO)

11. The surface according to claim 9, wherein the material of said plurality of resistance elements comprises low temperature silver paste.

12. The surface according to claim 9, wherein the material of said plurality of compensating elements is the same as the material of said uniform resistive surface.

13. The surface according to claim 9, wherein the geometric pattern of said compensating elements comprises a rectangle.

14. The surface according to claim 9, wherein the relationships of said sizes and said intervals among said plurality of compensating elements comprise the steps of:
LCn=((n*((DA/LA)*RG+RL)*C)/DB)−LC0
where n represents the compensated section number, LCn represents the compensated width of the n^{th} section (unit: inch), DA represents the line distance of each section of silver paste (unit: inch), LA represent the contact length between each section of silver paste and ITO (unit: inch), RG represent the glass surface resistance (unit: ohm), RL represents the line resistance of each section of silver paste (unit: ohm), C represents an adjust constant (about 45.3), DB represents the distance of silver paste pattern (unit: inch), and LC0 represents the width (a known value) of the 0^{th} section (unit: inch).
